(19) United States
(12) Patent Application Publication
(10) Pub. No.: US 2026/0193136 A1
(43) Pub. Date: Jul. 9, 2026

(54) CERAMIC SINTERED BODY

(71) Applicant: KYOCERA Corporation, Kyoto-shi, Kyoto (JP)

(72) Inventors: Kouji MATSUSHITA, Satsumasendai-shi, Kagoshima (JP); Yoshito TANI, Satsumasendai-shi, Kagoshima (JP); Yuuki TOMITA, Akune-shi, Kagoshima (JP)

(21) Appl. No.: 19/133,654

(22) PCT Filed: Nov. 29, 2023
(86) PCT No.: PCT/JP2023/042786

§ 371 Date: May 28, 2025

(30) Foreign Application Priority Data
Nov. 29, 2022 (JP) 2022-190454
Sep. 29, 2023 (JP) 2023-170655

(51) Int. Cl. C04B 35/10

(52) U.S. Cl. CPC C04B 35/10; C04B 2235/3206; C04B 2235/3217; C04B 2235/3232; C04B 2235/3267; C04B 2235/3272; C04B 2235/3418; C04B 2235/9661

(57) ABSTRACT

A ceramic sintered body contains 90 mass % or more of Al in terms of Al₂O₃, 0.4 mass % or more and 2.5 mass % or less of Si in terms of SiO₂, 3.0 mass % or more and 3.7 mass % or less of Mn in terms of MnO₂, 1.1 mass % or more and 1.7 mass % or less of Ti in terms of TiO₂, 1.1 mass % or more and 1.7 mass % or less of Fe in terms of Fe₂O₃, and 0.05 mass % or more and 0.3 mass % or less of Mg in terms of MgO. The ceramic sintered body has a ΔE value of 0 or more and 36 or less, calculated based on a*, b*, and L*.

### TECHNICAL FIELD

The present disclosure relates to a ceramic sintered body.

### BACKGROUND OF INVENTION

Patent Literature 1 discloses a known ceramic sintered body that is used for a mounting substrate, a member for an exposure treatment device, a light shielding material, a heat absorbing material, and the like. Such a ceramic sintered body has, for example, a black color and includes a composite oxide containing a plurality of metal elements.

### CITATION LIST

### Patent Literature

Patent Literature 1: JP H01-42359 A

### SUMMARY

A ceramic sintered body according to an aspect of an embodiment contains 90 mass % or more of Al in terms of Al₂O₃, 0.4 mass % or more and 2.5 mass % or less of Si in terms of SiO₂, 3.0 mass % or more and 3.7 mass % or less of Mn in terms of MnO₂, 1.1 mass % or more and 1.7 mass % or less of Ti in terms of TiO₂, 1.1 mass % or more and 1.7 mass % or less of Fe in terms of Fe₂O₃, and 0.05 mass % or more and 0.3 mass % or less of Mg in terms of MgO. The ceramic sintered body has a ΔE value of 0 or more and 36 or less, calculated based on a*, b*, and L*.

### DESCRIPTION OF EMBODIMENTS

The ceramic sintered body described above, for example, has poor bending strength, leaving room for improvement.

Thus, it is expected to provide a black ceramic sintered body having excellent bending strength.

An embodiment of a ceramic sintered body disclosed in the present application will be described in detail below. Note that this invention is not limited to the following embodiment.

The ceramic sintered body of the present disclosure contains Al, Si, Mn, Ti, Fe, and Mg. The ceramic sintered body of the present disclosure contains a plurality of metal oxides.

The ceramic sintered body of the present disclosure exhibits a black color. Specifically, in the ceramic sintered body of the present disclosure, ΔE calculated based on a*, b*, and L* is 36 or less. Here, a*, b*, and L* are values based on the CIE 1976 (L*a*b*) color space in accordance with JIZ Z 8781-4 2013. a*, b*, and L* can be measured using a spectrocolorimeter, for example, CM-700d available from Konica Minolta, Inc., at a wavelength of from 400 nm to 700 nm. The measurement may be performed with a field of view of 10°. A main light source may be D65, and an illumination diameter may be measured under measurement conditions of an aperture of φ6 mm (SAV), SCE (Specular Component Exclude), and measuring after white calibration. Reflectance may be measured, for example, using CM-2600d available from Konica Minolta, Inc., under conditions of SCE (Specular Component Exclude) and a wavelength of from 360 nm to 740 nm. a*, b*, and L* can also be adjusted by firing temperature and firing time in addition to composition of the metal oxides contained in the ceramic sintered body of the present disclosure. ΔE is a value calculated based on a calculation formula of ΔE=(a*²+b*²+L*²)^{0.5}. When ΔE has a value of 0, a*, b*, and L* all have values of 0, indicating a black color. Conversely, an increase in the value of ΔE indicates that the color shifts away from black. When ΔE is 36 or less, in other words, it can be said that the color is sufficiently close to black.

The ceramic sintered body of the present disclosure contains 90 mass % or more of Al in terms of Al₂O₃. The ceramic sintered body of the present disclosure may contain 90 mass % or more and 95 mass % or less of Al. The content of Al may be adjusted according to contents of other components to be described later.

The ceramic sintered body of the present disclosure contains 0.4 mass % or more and 2.5 mass % or less of Si in terms of SiO₂. As a result, it becomes easier to achieve a sufficient density suitable for an application, and becomes easier to obtain a ceramic sintered body having excellent bending strength. The ceramic sintered body of the present disclosure may contain 0.9 mass % or more and 2.0 mass % or less of Si in terms of SiO₂. With such composition, a ceramic sintered body with particularly high strength is easily obtained.

The ceramic sintered body of the present disclosure contains 3.0 mass % or more and 3.7 mass % or less of Mn in terms of MnO₂. This makes it easier to obtain a ceramic sintered body having ΔE of 36 or less. In addition, it is easier to obtain an insulating ceramic sintered body in which a* and b* are-2.0 or more and 2.0 or less and L* is 0 or more and 36 or less, and which has excellent bending strength, and further has high volume resistivity.

The ceramic sintered body of the present disclosure contains 1.1 mass % or more and 1.7 mass % or less of Ti in terms of TiO₂. This makes it easier to obtain a ceramic sintered body having ΔE of 36 or less. In addition, it is easier to obtain a ceramic sintered body in which a* and b* are-2.0 or more and 2.0 or less and L* is 0 or more and 36 or less, and which has excellent bending strength.

The ceramic sintered body of the present disclosure contains 1.1 mass % or more and 1.7 mass % or less of Mn in terms of Fe₂O₃. This makes it easier to obtain a ceramic sintered body having ΔE of 36 or less. In addition, it is easy to obtain an insulating ceramic sintered body in which a* and b* are-2.0 or more and 2.0 or less and L* is 0 or more and 36 or less, and which has excellent bending strength, and further has high volume resistivity.

The ceramic sintered body of the present disclosure contains 0.05 mass % or more and 0.3 mass % or less of Mg in terms of MgO. As a result, the ceramic sintered body of the present disclosure is less prone to grain growth and is more likely to have excellent bending strength.

In the ceramic sintered body of the present disclosure, the content of Mn in terms of MnO₂ may be 2 or more times and 5 or less times the content of Fe in terms of Fe₂O₃. As a result, a* and b* are likely to be close to 0, it is more likely to obtain an insulating ceramic sintered body having excellent bending strength and high volume resistivity. Since Mn is dispersed at a grain boundary of an alumina base material, visible light in a low wavelength range to a middle wavelength range is easily absorbed, so that reflection of visible light in a long wavelength range is relatively increased. Thus, the ceramic sintered body of the present disclosure easily reflects infrared light, for example. In particular, when the content of Mn in terms of MnO₂ is 2.5 or more times the content of Fe in terms of Fe₂O₃, the above effect is remarkable.

The ceramic sintered body of the present disclosure may have a volume resistivity of 10⁹ Ω·m or more and a three-point bending strength of 310 MPa or more. This results in a ceramic sintered body suitable for an application requiring relatively high insulation resistance and physical strength.

In the ceramic sintered body of the present disclosure, a* and b* may be −1.5 or more and 1.5 or less. This results in a ceramic sintered body suitable for an application requiring a black color in particular.

In the ceramic sintered body of the present disclosure, a sum of the content of Mn in terms of MnO₂ and the content of Fe in terms of Fe₂O₃ may be 4.5 mass % or more and 6.9 mass %. As a result, a* and b* are likely to be close to 0, it is more likely to obtain an insulating ceramic sintered body having excellent bending strength, and high volume resistivity.

Each metal element contained in the ceramic sintered body of the present disclosure can be quantified using an X-ray fluorescence analyzer (XRF). The content of each metal element obtained by the measurement is converted into a value in terms of a corresponding metal oxide, and is defined as a proportion of each metal element. Specifically, for example, the content of Al is converted in terms of Al₂O₃, the content of Si is converted in terms of SiO₂, the content of Mn is converted in terms of MnO₂, the content of Ti is converted in terms of TiO₂, the content of Fe is converted in terms of Fe₂O₃, and the content of Mg is converted in terms of MgO. When the ceramic sintered body contains a metal element besides these metal elements, its content may be converted in terms of a representative metal oxide of the element.

The ceramic sintered body of the present disclosure may not contain Co and Cr. In such a case, the ceramic sintered body of the present disclosure can be provided at low cost because expensive Co and Cr are not used. The phrase “may not contain Co and Cr” means that contents of Co and Cr are equal to or less than a detection limit of the X-ray fluorescence analyzer (XRF).

An example of a method for manufacturing the ceramic sintered body of the present disclosure is described.

Al₂O₃, Fe₂O₃, and MnO₂ in particle or powder form are mixed, and TiO₂, SiO₂, and MgO are added as sintering aids. Each raw material powder may have a particle diameter, for example, of from 0.1 μm to 5 μm. Water and a binder are added, mixed and stirred to produce slurry. A molded body having a desired shape is prepared using the resultant slurry, and fired in an oxidizing atmosphere, whereby the ceramic sintered body of the present disclosure is obtained. A known method such as press molding can be used for preparing the molded body.

The firing temperature during firing may be, for example, 1350° C. or higher and 1550° C. or lower. The firing time may be, for example, about 2 hours. The firing atmosphere may be the atmosphere.

Applications of the ceramic sintered body of the present disclosure will be described. For example, the ceramic sintered body of the present disclosure exhibits a black color, and thus can be used as a member for an exposure treatment device, a light shielding material, a heat absorbing material, and the like. The ceramic sintered body of the present disclosure has an excellent mechanical characteristic and an excellent electrical characteristic, and thus can also be used as a mounting substrate, or a structural component or a functional component of industrial machinery and equipment. The ceramic sintered body of the present disclosure exhibits a black color and has an excellent mechanical characteristic, and thus may be used as a sliding member or a decorative member of a thread path component, fishing gear, and the like.

### EXAMPLES

Ceramic sintered bodies having different compositions were prepared, and mechanical strength (three-point bending strength), volume resistivity, a*, b*, and L* were measured. Then, ΔE was determined based on the obtained a*, b*, and L*. ΔE was calculated based on a following relational expression (Formula 1). When not specifically described, a*, b*, and L* were measured on a fired surface of the sintered body.

$$Δ E = {( {a}^{* 2} + {b}^{* 2} + {L}^{* 2} )}^{0.5} \qquad ( Formula 1 )$$

First, Al₂O₃ powder, SiO₂ powder, MnO₂ powder, TiO₂ powder, Fe₂O₃ powder, and MgO powder were provided.

Then, the sintered ceramics were weighed so that a mass proportion of Al in terms of Al oxide (Al₂O₃), a mass proportion of Si in terms of Si oxide (SiO₂), a mass proportion of Mn in terms of Mn oxide (MnO₂), a mass proportion of Ti in terms of Ti oxide (TiO₂), a mass proportion Fe in terms of Fe oxide (Fe₂O₃), and a mass proportion of Mg in terms of Mg oxide (MgO) were values in Table 1.

The weighed powders were mixed and molded to obtain a molded body having a desired shape.

The molded body was fired using a firing furnace in the atmosphere (an oxidizing atmosphere) to obtain sintered body samples.

Each sample was then measured using XRD to confirm the presence of aluminum oxide (alumina). For each sample, after mirror polishing, Al, Si, Mn, Ti, Fe and Mg were measured using XRF to determine a content of each element, and the determined content of the element was converted into a content of each oxide to calculate the proportion of each element shown in Table 1.

Using the obtained sintered body, the three-point bending strength was measured in accordance with JIS R 1601-2008, and the results were shown in Table 1.

Using the obtained sintered body, a*, b* and L* based on the CIE 1976 (L*a*b*) color space were measured in accordance with JIS Z 8722-2000, and ΔE was calculated using the above-described (Formula 1). The results are listed in Table 1.

TABLE 1

| | Al | Si | Mg | Ti | Mn | Fe | | Three-point | Volume | | | | |
|---|---|---|---|---|---|---|---|---|---|---|---|---|---|
| | (Al₂O₃ | (SiO₂ | (MgO | (TiO₂ | (MnO₂ | (Fe₂O₃ | | bending | resistivity | | | | |
| Sample | conversion) | conversion) | conversion) | conversion) | conversion) | conversion) | MnO₂/ | strength | (×10⁹ | | | | |
| No. | (mass %) | (mass %) | (mass %) | (mass %) | (mass %) | (mass %) | Fe₂O₃ | (MPa) | Ω · m) | a* | b* | L* | ΔE |
| 1 | 93.7 | 0.3 | 0.1 | 1.4 | 3.1 | 1.4 | 2.2 | 280 | 1 | 1.0 | 0.5 | 34 | 34 |
| 2 | 93.6 | 0.4 | 0.1 | 1.4 | 3.1 | 1.4 | 2.2 | 320 | 1 | 1.0 | 0.5 | 34 | 34 |
| 3 | 91.5 | 2.5 | 0.1 | 1.4 | 3.1 | 1.4 | 2.2 | 350 | 1 | 1.0 | 0.5 | 34 | 34 |
| 4 | 91 | 3 | 0.1 | 1.4 | 3.1 | 1.4 | 2.2 | 250 | 1 | 1.0 | 0.5 | 34 | 34 |
| 5 | 93 | 1.1 | 0 | 1.4 | 3.1 | 1.4 | 2.2 | 250 | 1 | 1.0 | 0.5 | 34 | 34 |
| 6 | 92.95 | 1.1 | 0.05 | 1.4 | 3.1 | 1.4 | 2.2 | 310 | 1 | 1.0 | 0.5 | 34 | 34 |
| 7 | 92.7 | 1.1 | 0.3 | 1.4 | 3.1 | 1.4 | 2.2 | 340 | 1 | 1.0 | 0.5 | 34 | 34 |
| 8 | 92.6 | 1.1 | 0.4 | 1.4 | 3.1 | 1.4 | 2.2 | 270 | 1 | 1.0 | 0.5 | 34 | 34 |
| 9 | 93.4 | 1 | 0.1 | 1 | 3.1 | 1.4 | 2.2 | 330 | 1 | 2.2 | 2.1 | 37 | 37 |
| 10 | 93.3 | 1 | 0.1 | 1.1 | 3.1 | 1.4 | 2.2 | 330 | 1 | 1.3 | 0.8 | 35 | 35 |
| 11 | 92.7 | 1 | 0.1 | 1.7 | 3.1 | 1.4 | 2.2 | 320 | 1 | 0.9 | 0.5 | 34 | 34 |
| 12 | 92.6 | 1 | 0.1 | 1.8 | 3.1 | 1.4 | 2.2 | 290 | 1 | 0.9 | 0.5 | 34 | 34 |
| 13 | 93.6 | 1 | 0.1 | 1.4 | 2.5 | 1.4 | 1.8 | 340 | 3 | 2.0 | 2.5 | 34 | 34 |
| 14 | 93.1 | 1 | 0.1 | 1.4 | 3 | 1.4 | 2.0 | 330 | 3 | 1.2 | 0.8 | 34 | 34 |
| 15 | 93 | 1 | 0.1 | 1.4 | 3.1 | 1.4 | 2.2 | 320 | 3 | 1.0 | 0.5 | 34 | 34 |
| 16 | 92.4 | 1 | 0.1 | 1.4 | 3.7 | 1.4 | 2.6 | 310 | 2 | 1.2 | 0.4 | 34 | 34 |
| 17 | 92.3 | 1 | 0.1 | 1.4 | 3.8 | 1.4 | 2.7 | 295 | 1.5 | 1.3 | 0.4 | 34 | 34 |
| 18 | 93.4 | 1 | 0.1 | 1.4 | 3.1 | 1 | 3.1 | 340 | 2.6 | 1.1 | 0.4 | 37 | 37 |
| 19 | 93.3 | 1 | 0.1 | 1.4 | 3.1 | 1.1 | 2.8 | 330 | 2.5 | 1.0 | 0.5 | 34 | 34 |
| 20 | 92.7 | 1 | 0.1 | 1.4 | 3.1 | 1.7 | 1.8 | 325 | 2.5 | 1.4 | 1.4 | 34 | 34 |
| 21 | 92.6 | 1 | 0.1 | 1.4 | 3.1 | 1.8 | 1.7 | 320 | 2.6 | 2.1 | 2.6 | 34 | 34 |

As shown in sample Nos. 1 and 4, when Si was contained in an amount of less than 0.4 mass % or more than 2.5 mass % in terms of SiO₂, the three-point bending strength was less than 310 MPa, and a ceramic sintered body having poor bending strength was obtained.

As shown in sample Nos. 5 and 8, when Mg was contained in an amount of less than 0.05 mass % or more than 0.3 mass % in terms of MgO, the three-point bending strength was less than 310 MPa, and a ceramic sintered body having poor bending strength was obtained.

As shown in sample No. 9, when Ti was contained in an amount of less than 1.1 mass % in terms of TiO₂, ΔE was more than 36. A ceramic sintered body in which a* and b* were more than 2.0 and L* was more than 36 was obtained. As shown in sample No. 12, when

Ti was contained in an amount of more than 1.7 mass % in terms of TiO₂, the three-point bending strength was less than 310 MPa, and a ceramic sintered body having poor bending strength was obtained.

As shown in sample No. 13, when Mn was contained in an amount of less than 3.0 mass % in terms of MnO₂, a ceramic sintered body having b* of more than 2.0 was obtained.

As shown in sample No. 17, when Mn was contained in an amount of more than 3.7 mass % in terms of MnO₂, the three-point bending strength was less than 310 MPa, and a ceramic sintered body having poor bending strength was obtained.

As shown in sample No. 18, when Fe was contained in an amount of less than 1.1 mass % in terms of Fe₂O₃, ΔE was more than 36. A ceramic sintered body in which L* was more than 36 was obtained. As shown in sample No. 21, when Fe was contained in an amount of more than 1.7 mass % in terms of Fe₂O₃, a ceramic sintered body in which a and b* were more than 2.0 was obtained.

On the other hand, as shown in sample Nos. 2, 3, 6, 7, 10, 11, 14 to 16, and 19, a ceramic sintered body containing 90 mass % or more of Al in terms of Al₂O₃, 0.4 mass % or more and 2.5 mass % or less of Si in terms of SiO₂, 3.0 mass % or more and 3.7 mass % or less of Mn in terms of MnO₂, 1.1 mass % or more and 1.7 mass % or less of Ti in terms of TiO₂, 1.1 mass % or more and 1.7 mass % or less of Fe in terms of Fe₂O₃, and 0.05 mass % or more and 0.3 mass % or less of Mg in terms of MgO had a volume resistivity of 109 (2·m or more and a three-point bending strength of 310 MPa or more. As described above, the ceramic sintered body of the present disclosure has relatively high insulation resistance and physical strength. In the ceramic sintered body of the present disclosure, ΔE was 36 or less. a* and b* were 0 or more and 2.0 or less, L′ was 0 or more and 36 or less, and a black color was exhibited.

When the content of MnO₂ was 2 or more times the content of Fe₂O₃ ((MnO₂/Fe₂O₃)≥2), a ceramic sintered body having low a* and b* was obtained.

A molded body having the same composition as that of sample No. 15 in Table 1 was fired at a temperature lower than that of sample No. 15 by 50° C. to prepare a ceramic sintered body. Properties of the sintered body are shown in Table 2.

TABLE 2

| | Three-point | | | | | |
|---|---|---|---|---|---|---|
| | bending | Volume | | | | |
| Sample | strength | resistivity | | | | |
| No. | (MPa) | (×10⁹ Ω · m) | a* | b* | L* | ΔE |
| 22 | 330 | 2.3 | 0.8 | −1.0 | 35 | 35 |
| 23 | 330 | 2.3 | 4.9 | 6.7 | 19 | 21 |

Values of a*, b*, L*, and ΔE of sample No. 22 in Table 2 were measured on the fired surface in the same manner as in Table 1. Values of a*, b*, L*, and ΔE of sample No. 23 in Table 2 were measured on a mirror-finished surface, that is, a mirror surface. In the ceramic sintered body of the present disclosure, when mirror finishing was performed, L* and ΔE tended to be smaller than those of the fired surface. On the other hand, in the ceramic sintered body of the present disclosure, when mirror finishing was performed, a* and b* tended to be larger than those of the fired surface. The strength of the ceramic sintered body of the present disclosure was less affected by the firing temperature. From the viewpoint of reflectance, the ceramic sintered body of the present disclosure showed a reflectance of 15% or less. The ceramic sintered body of the present disclosure showed a reflectance of 12% or less on the mirror surface. In the ceramic sintered body of the present disclosure, when the fired surface and the mirror surface were compared, the mirror surface tended to have a lower reflectance.

While the present disclosure has been described in detail, the present disclosure is not limited to the aforementioned embodiments, and various changes, improvements, and the like can be made without departing from the gist of the present disclosure.

Further effects and variations can be readily derived by those skilled in the art. Thus,

the broader aspects of the present invention are not limited to the specific details and representative embodiments represented and described above. Accordingly, various changes are possible without departing from the spirit or scope of the general inventive concepts defined by the appended claims and their equivalents. For example, the ceramic sintered body of the present disclosure exhibits a black color and thus can be used as a member for an exposure treatment device, a light shielding material, a heat absorbing material, and the like. The ceramic sintered body of the present disclosure has an excellent mechanical characteristic and an excellent electrical characteristic, and thus can also be used as a mounting substrate, or a structural component or a functional component of an industrial machinery and equipment. The ceramic sintered body of the present disclosure exhibits a black color and has an excellent mechanical characteristic and thus may be used as a sliding member or a decorative member of a thread path component, fishing gear, and the like.

1. A ceramic sintered body comprising:
90 mass % or more of Al in terms of Al₂O₃;
0.4 mass % or more and 2.5 mass % or less of Si in terms of SiO₂;
3.0 mass % or more and 3.7 mass % or less of Mn in terms of MnO₂;
1.1 mass % or more and 1.7 mass % or less of Ti in terms of TiO₂;
1.1 mass % or more and 1.7 mass % or less of Fe in terms of Fe₂O₃; and
0.05 mass % or more and 0.3 mass % or less of Mg in terms of MgO,
wherein ΔE calculated based on a*, b*, and L* is 0 or more and 36 or less.

2. The ceramic sintered body according to claim 1, wherein the a* and the b* are-2.0 or more and 2.0 or less, and the L* is 0 or more and 36 or less.

3. The ceramic sintered body according to claim, wherein a content of the Mn in terms of MnO₂ is 2 or more times and 5 or less times a content of the Fe in terms of Fe₂O₃.

4. The ceramic sintered body according to claim 1, wherein a volume resistivity is 10⁹ Ω·m or more, and a three-point bending strength is 310 MPa or more.

5. The ceramic sintered body according to claim 1, wherein the a* and the b* are 1.5 or less.
